(19) United States
(12) Patent Application Publication
(10) Pub. No.: US 2018/0281753 A1
(43) Pub. Date: Oct. 4, 2018

(54) APPARATUS AND METHOD FOR CLEANING A TRACTOR-TRAILER

(71) Applicant: MAC TRAILER MANUFACTURING, INC., Alliance, OH (US)

(72) Inventor: Michael A. Conny, Beloit, OH (US)

(73) Assignee: MAC TRAILER MANUFACTURING, INC.

(21) Appl. No.: 15/937,027

(22) Filed: Mar. 27, 2018

Related U.S. Application Data
(60) Provisional application No. 62/478,067, filed on Mar. 29, 2017.

(51) Int. Cl. B60S 3/06; B60S 3/00; B62D 63/04; B08B 1/00; B08B 1/04; B08B 9/087

(52) U.S. Cl. CPC B60S 3/063; B60S 3/008; B08B 9/087; B08B 1/002; B08B 1/04; B62D 63/04

(57) ABSTRACT

An apparatus and method for cleaning a large object such as a tractor-trailer. The apparatus is a cleaning vehicle including a frame with a plurality of wheels mounted thereon that allow the frame to move from one location to another across the ground. An arm mounted on the frame includes arm portions that may be telescoped to longitudinally, transversely, or vertically adjust the length of the arm portions. At least one rotatable brush is operatively engaged with the arm. The vehicle is positioned adjacent the large object and the arm is adjusted to position the at least one brush adjacent a surface to be cleaned. The arm portions are actuated to change length and thereby move the brush across the object's surface to clean the same. If two brushes are provided on the arm they may be moved toward or away from each other to clean two surfaces simultaneously.

### CROSS REFERENCE TO RELATED APPLICATIONS

This application claims the benefit of U.S. Provisional Application Ser. No. 62/478,067, filed on Mar. 29, 2017; the disclosure of which is incorporated herein by reference.

### BACKGROUND

### Technical Field

The present invention relates generally to an apparatus and method for cleaning large objects such as vehicles. More particularly, the present invention is directed to an apparatus and method for cleaning a large vehicle such as a tractor-trailer. Specifically, the invention is a mobile cleaning vehicle that may move from one location to another and includes an extendable arm upon which is mounted one or more brushes; the brushes being rotatable and movable in various direction by the arm relative to a surface of the tractor-trailer to clean the vehicle.

### Background Information

Tractor-trailers play very important roles in transporting goods and freight. Due to heavy demands on these vehicles, it is economically important that once a cargo is unloaded, the tractor-trailer get back onto the road as quickly as possible. Since these vehicles usually operate on highways, their exterior surfaces tend to get dirty quite rapidly. However, since tractor-trailers are so large, they are most easily cleaned in specially designed, large-size automated truck washes. Such large scale automatic machines are only available in certain locations and such locations may not be on a driver's route. As a result, it is not uncommon for drivers to personally wash their vehicles by hand. This can be a time-consuming, labor intensive operation.

In other instances a truck stop may include a commercial operation where tractor-trailers may be washed by hand by crews of several people. Cleaning these trucks by hand is quite challenging because of the size of the tractor-trailer's surfaces and the difficulty involved with adequately cleaning such surfaces with hand-held brushes.

### SUMMARY

There is therefore a need in the art for an improved method and apparatus for cleaning large objects, such as tractor-trailers, in areas that are remote from automated truck washing machines.

An apparatus and method of cleaning a large object such as a tractor trailer is disclosed herein. The apparatus comprises a cleaning vehicle including a frame with a plurality of wheels mounted thereon. The wheels allow the frame to move from one location to another across the ground. An arm is mounted on the frame and at least one rotatable brush is operatively engaged with the arm. The arm may be adjusted in length and the location and orientation of the arm and brush may be adjusted relative to the surface to be cleaned. The cleaning vehicle is positioned adjacent the large object to be cleaned and the arm is adjusted to position the brush adjacent a surface to be cleaned. The arm is actuated to move the brush across the object's surface to clean the same. If two brushes are provided on the arm, then the brushes may be moved toward or away from each other to clean two surfaces simultaneously.

In one aspect, the present disclosure may provide a method of cleaning a large object, comprising steps of providing a clearing vehicle that is movable from one location to another; moving the cleaning vehicle alongside a large object to be cleaned; positioning a brush mounted on the cleaning vehicle proximate a surface to be cleaned on the large object; contacting the surface with the brush; actuating the brush; and cleaning the surface with the actuated brush. The cleaning includes moving the brush along the surface. Moving the brush may include moving the brush laterally or longitudinally or vertically along the surface and rotating the brush while doing so. The method may further include mounting an arm on the cleaning vehicle; and mounting the brush on the arm. The arm is selectively extendable or selectively retractable; and the method includes extending or retracting the arm to position the brush in contact with the surface or to clean the surface with the brush. The method may further include extending or retracting the arm longitudinally, extending or retracting the arm transversely, or extending or retracting the arm vertically. The positioning of the brush includes positioning the brush in contact with an interior surface or an exterior surface of a tractor-trailer′ side wall or rear wall or front wall.

In another aspect the present disclosure may provide an apparatus for cleaning for a large object such as a tractor-trailer, comprising a frame with a plurality of wheels mounted on the frame, wherein the wheels are adapted to move the frame from one location to another across a ground surface; an arm mounted to the frame; wherein the arm is selectively adjustable in length; at least one brush operatively engaged with the arm. The arm includes a base that is vertically oriented relative to the frame and is rotatable about a vertical axis. The arm further includes a first arm that is pivotally engaged with the base; and the first arm is pivotable up or down relative to the frame; and the first arm is longitudinally adjustable in length. The arm further includes a second arm that is engaged with the first arm that is transversely adjustable in length. The arm may further include at least one third arm that is engaged with the second arm where the at least one third arm is vertically adjustable in length. The at least one brush is a single brush that is mounted on each of the at least one third arm and the single brush is mounted for rotation about a vertical axis. In some instances the at least one third arm comprises two third arms, and a single brush is mounted for rotation on each of the two third arms; and wherein the second arm is adjustable in length to move the two third arms closer to each other or further away from each other.

In another aspect, an apparatus and method of cleaning a large object such as a tractor trailer. The apparatus is a cleaning vehicle including a frame with a plurality of wheels mounted thereon that allow the frame to move from one location to another across the ground. An arm mounted on the frame includes arm portions that are selectively adjustable in length. Portions of the arm may be longitudinally, transversely, or vertically adjusted in length. A rotatable brush is operatively engaged with the arm. The vehicle is positioned adjacent the large object and the arm is adjusted to position the brush adjacent a surface to be cleaned. The arm portions are actuated to change length and thereby move the brush across the object's surface to clean the same. If two brushes are provided on the arm, then the brushes may be moved toward or away from each other to clean two surfaces simultaneously.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1A is a side elevation view of a first embodiment of a cleaning vehicle in accordance with the present invention; where the cleaning vehicle is shown positioned rearwardly of a trailer of a tractor-trailer and with a cleaning arm extending from the cleaning vehicle and positioned to clean a side wall of the trailer;

FIG. 1B is a side elevation view of a second embodiment of a cleaning vehicle in accordance with the present invention; where the cleaning vehicle is a telescopic handler (also known as a telehandler) shown positioned rearwardly of a trailer of a tractor-trailer and with a cleaning arm extending from the cleaning vehicle and positioned to clean a side wall of the trailer;

FIG. 2 is a top perspective view of the cleaning vehicle of FIG. 1A shown cleaning the exterior surfaces of both side walls of the trailer at the same time;

FIG. 3 is a rear end elevation view of the trailer of FIG. 2 taken along line 3-3 of FIG. 1A, showing two brushes hanging from a part of the cleaning arm; where the brushes are positioned to simultaneously clean the exterior surfaces of the two side walls of the trailer;

FIG. 4 is a top perspective view of the cleaning vehicle of FIG. 1A shown with the brushes on the cleaning arm positioned to clean both of the inner surfaces of the trailer at the same time;

FIG. 5 is a rear end elevation view of the trailer of FIG. 4 taken along line 5-5 of FIG. 1A, showing the two brushes hanging from a part of the cleaning arm, where the brushes are positioned to simultaneously clean the inner surfaces of the side walls of the trailer;

FIG. 6 is a rear end elevation view of the trailer showing the two brushes hanging from a part of the cleaning arm, where the brushes are positioned on the cleaning arm to clean an inner surface and an outer surface of one side wall of the trailer at the same time.

Similar numbers refer to similar parts throughout the drawings.

### DETAILED DESCRIPTION

The present disclosure relates to an apparatus and method for cleaning large objects such as tractor-trailers, containers, cube van, trucks, building walls etc. The apparatus comprises a mobile cleaning vehicle that is movable from one location to another. The cleaning vehicle has an extendable cleaning arm mounted thereon and is provided with one or more brushes that can be swept along surfaces of the large object to clean the same. The one or more brushes may be moved vertically, horizontally, laterally, longitudinally and/or at any of a variety of different angles across the surface to be cleaned. Each brush may rotate about an axis that extends along a shaft of the brush. If more than one brush is provided on the cleaning arm, the positions of the brushes relative to each other may be changed. The apparatus and method will be described in greater detail hereafter.

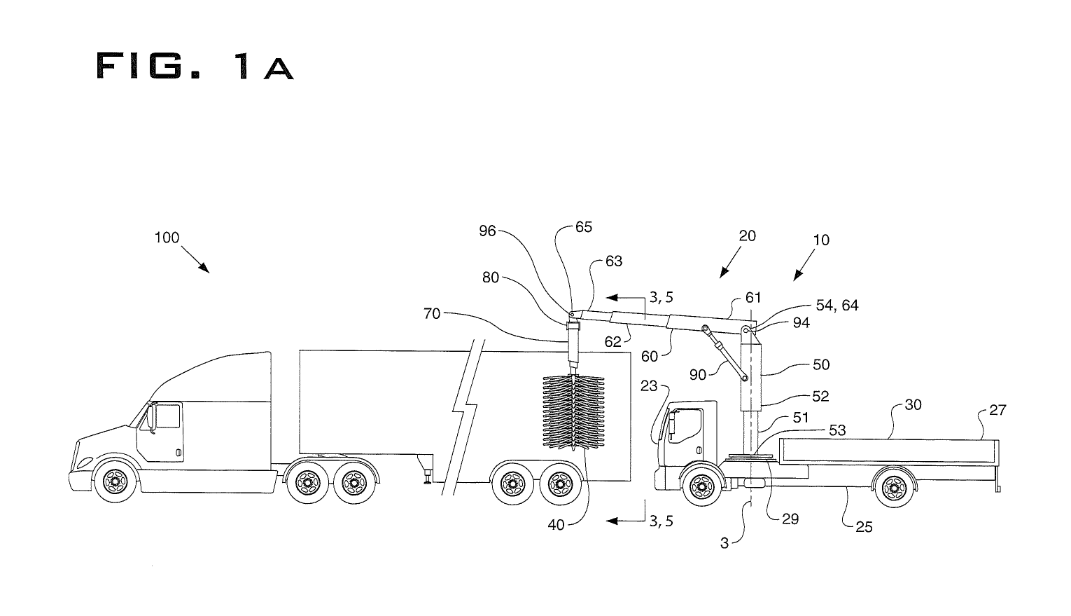

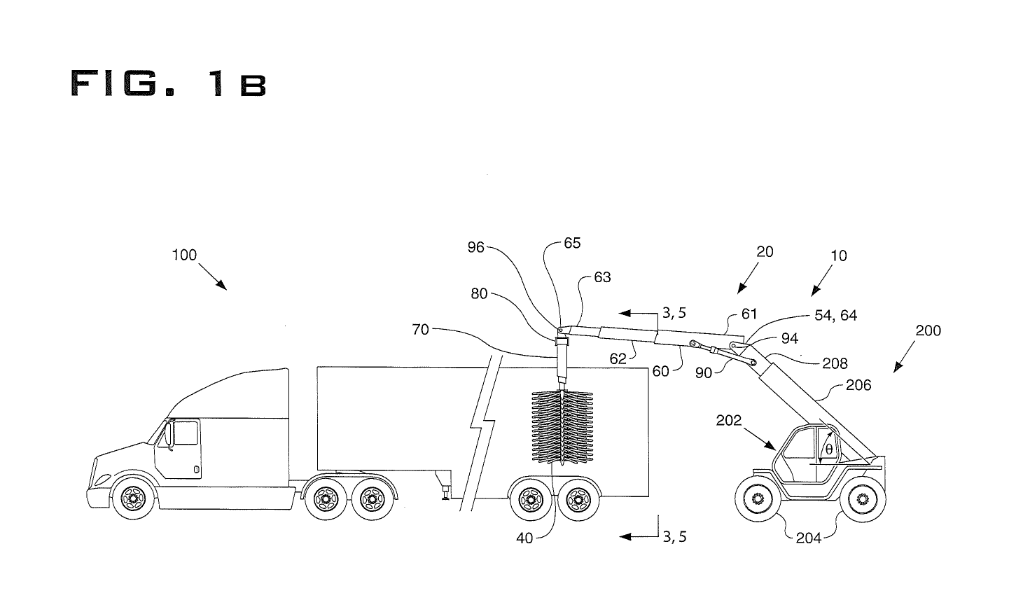

Cleaning vehicle 10 may comprise a cleaning module 20 that is mounted on a transportation module 30. As depicted in FIG. 1A, the transportation module 30 may include a cab 23 mounted on a frame 25, a motor, and a plurality of wheels. Cab 23 is sized and outfitted so that a driver may be able to sit inside cab 23 and operate cleaning vehicle 10. Transportation module 30 may further include a bed 27 mounted on frame 25. The purpose of bed 27 will be further described later herein. Cleaning vehicle 10 may move across a surface (such as a road or parking lot) from one location to another. Cleaning vehicle 10 may, for example, be driven from adjacent a first tractor-trailer 100 in a first location to a position adjacent a second tractor-trailer or other object (not shown) in a second location. In other words, cleaning vehicle 10 is moved to the location of the large object to be cleaned instead of the large object being moved to the location of cleaning vehicle 10. Cleaning vehicle 10 thus comprises a mobile cleaning station instead of comprising a stationary cleaning station.

A mounting assembly 29 is provided on frame 25 and is utilized to mount cleaning module 20 on transportation module 30. Cleaning module 20 includes an extendable arm that is mounted to transportation module 30 using mounting assembly 29. The extendable arm comprises a base 50, a first arm 60, and a second arm 80, and a third arm 70.

Base 50 is a vertically oriented member that extends upwardly from mounting assembly 29 on frame 25. Base 50 includes a first portion 51 and a second portion 52. A first end 53 of first portion 51 of base 50 is operatively engaged with mounting assembly 29. A second end 54 of second portion 52 of base 50 is pivotally engaged with first arm 60. First and second portions 51, 52 of base 50 are able to telescope relative to each other and thereby change the overall height of base 50. (The height of base 50 is the distance between first end 53 and second end 54.) First end 53 of base 50 may be engaged with mounting assembly 29 in such a way that base 50 is able to be pivoted about a vertical axis 3 through an angle of up to about 360°.

First arm 60 is pivotally connected to second end 54 of base 50 by way of a pivotable connector such as a pivot pin 94. Pivot pin 94 is configured so that first arm 60 may be pivoted upwardly or downwardly relative to frame 25. First arm 60 may comprise a first portion 61, a second portion 62, and a third portion 63 that are telescopingly engaged with each other. A first end 64 of first portion 61 is pivotally engaged with second end 54 of base 50 via pivot pin 94. A second end 65 of third portion 63 is engaged with second arm 80. First portion 61, second portion 62, and third portion 63 are able to telescope longitudinally relative to each other to change the overall length of first arm 60. The length of first arm 60 is the distance between first end 64 and second end 65. A pair of hydraulic actuators 90 is engaged between second portion 52 of base 50 and first portion 61 of first arm 60. Actuators 90 may be actuated to raise or lower first arm 60, i.e., to cause first arm 60 to pivot about pivot pin 94.

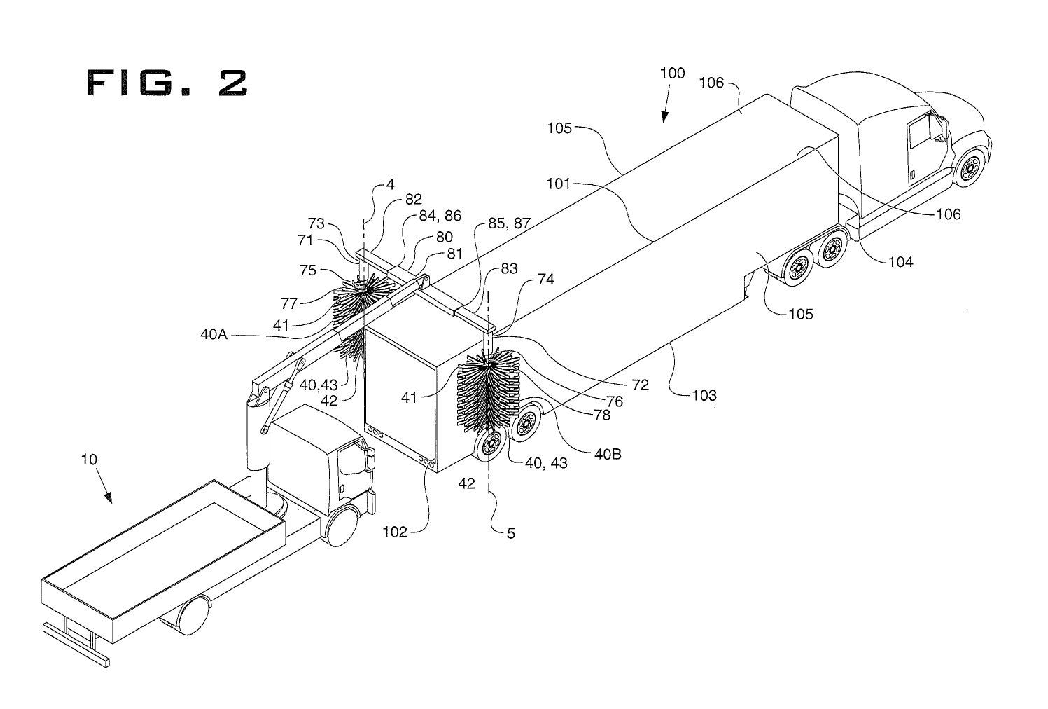

Referring to FIGS. 1A and 2, a transversally extendable second arm 80 is pivotally engaged with second end 65 of first arm 60 via a pivot pin 96. While second arm 80 is pivotally engaged with first arm 60, it should be noted that the pivotal connection via pivot pin 96 is such that central portion 81 of second arm 80 is oriented substantially at ninety degrees to first arm 60. Second arm 80 may comprise a central portion 81, a first portion 82, and a second portion 83. Central portion 81 is of a fixed length measured between first end 84, and second end 85. Central portion 81 defines one or two interior cavities 86, 87 therein. Second portion 82 is selectively able to telescope out of cavity 86 in a first direction. Third portion 83 is selectively able to telescope out of cavity 87 in a second direction. The overall length of second arm 80 may be adjusted by changing the extent to which one or both of first and second portions 82, 83 extend outwardly beyond the first end 84 and/or second end 85 of central portion 81.

A vertically extendable third arm 70 is engaged with each of the first portion 82 and the second portion 83 of second arm 80. In particular, a first arm 71 is fixedly engaged with first portion 82 of second arm 80 and a second arm 72 is fixedly engaged with second portion 83 of second arm 80. First arm 71 comprises a first portion 73, a second portion 75, and a third portion 77 that are able to telescope vertically relative to each other to change the overall length of first arm 71. Second arm 72 comprises a first portion 74, a second portion 76, and a third portion 78 that are able to telescope vertically relative to each other to change the overall length of second arm 72. The length of first arm 71 is measured from first portion 82 to a connection with a first brush 40A (described below). The length of second arm 72 is measure from second portion 83 to a connection with a second brush 40B (described below). First portion 73 of first arm 71 may be secured to first portion 82 of second arm 80 by welding or some other suitable fastener that substantially prevents relative movement between first portion 73 and first portion 82. Similarly, first portion 74 of second arm 72 may be secured to second portion 83 by welding or some other suitable fastener that substantially prevents relative movement between first portion 74 and second portion 83. First arm 71 and second arm 72 may each be oriented at about ninety degrees relative to second arm 80. It should be noted that first and second arm 71, 72 may be separately operable or may be simultaneously operable. When second arm 80 is adjusted in length, then first arm 71 and second arm 72 may selectively be moved closer towards each other or may be moved further away from each other.

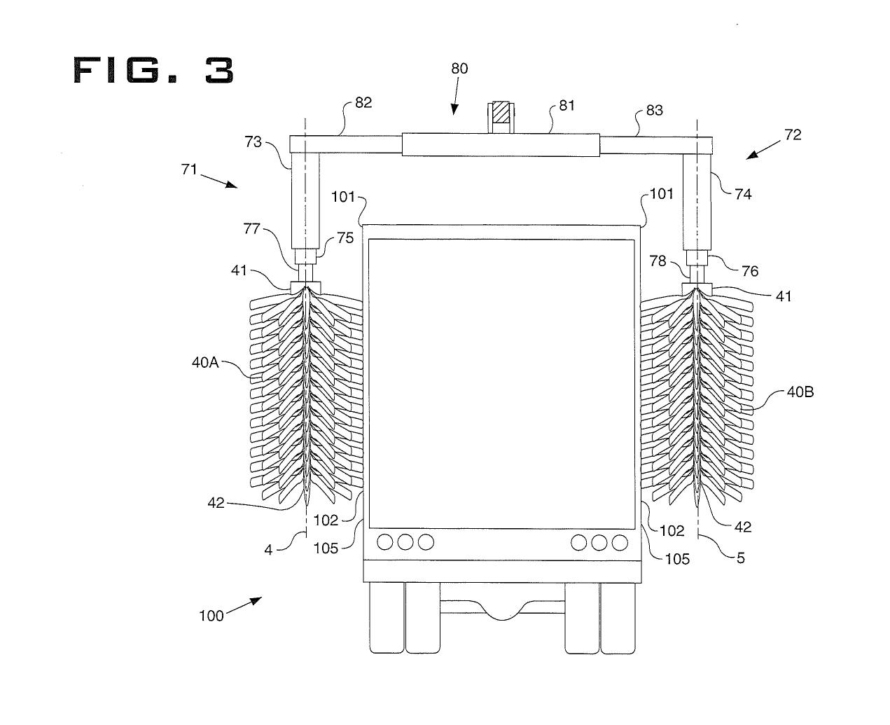

A brush 40 may be rotatably mounted to each of first arm 71 and second arm 72. In particular, a shaft of each brush 40 may be rotatably mounted to a lowermost end of the third portions 77, 78 of the first arm 71 and second arm 72, respectively. Upper end 41 of a first brush 40A is rotatably mounted to third portion 77 of first arm 71. Upper end 41 of a second brush 40B is rotatably mounted to third portion 78 of an additional second arm 72. Each brush 40 may comprise a brush body 43 having an upper end 41 (FIG. 3) and a lower end 42. Brush body 43 includes a shaft (not shown) from which a plurality of bristles extend outwardly. (The bristles may be fabricated from any suitable material such as strips of cloth or a flexible plastic.) First brush 40A may rotate about a first vertical axis 4 and second brush 40B may rotate about the second vertical axis 5. When the length of first arm 71 or second arm 72 is selectively changed, brushes 40A or 40B, respectively, may be moved closer to the ground or further away from the ground as desired.

One or more motors (or actuators) may be provided on cleaning vehicle 10 for operating one or more of base 50, first arm 60, second arm 80, third arms 71, 72, and brushes 40A and 40B. The one or motors may be actuated to change the overall length of one or more of arms 60, 80, 70 by selectively extending or retracting the telescoping portions thereof relative to each other. The one or more motors may be actuated to selectively rotate or to stop rotating brushes 40A and 40B. The motors may be operated to move, retract, extend, or rotate a selected one or more of the arms 60, 80, 70 or brushes 40 independently or to move, extend or rotate them concurrently or substantially simultaneously. The motors may be powered in any suitable manner including hydraulically, pneumatically, or electrically. Rotation and extension or retraction of the base 50, and arms 60, 70, 80 and brushes 40A, 40B can be powered by one motor or by a plurality of motors that are installed in the transportation module 30 or that are installed in the cleaning module 20. In one embodiment, a motor may be provided in transportation module 30 so that the base 50, and arms 60, 70, 80, which are mechanically interconnected each other, can be actuated concurrently or sequentially. In another embodiment, several different motors may be provided and each motor may operate separately and be used to operate one or more of base 50, and arms 60, 70 and 80 and/or brushes 40A, 40B. It will also be understood that the motor that enables transportation module 30 (or a telescopic handler 200 or “telehandler” as will be discussed later herein with respect to FIG. 1B) to move along the ground from location to location, may be used to actuate any or all of base 50, arms 60, 70, 80, and brushes 40A, 40B (or arm portions 206, 208 of telehandler 200 as will be discussed later herein).

The motor(s) that control base, the first arm 60, second arm 80, and third arm 70 to telescope outwardly to increase the length of the associated base or arm; or to telescope inwardly to decrease the length thereof, may operate substantially continuously. This may permit the operator to progressively clean the surface of trailer 100, for example, by causing the brushes 40 to move substantially steadily across the surface to be cleaned. In other instances, the operator may hold the brushes 40 in a particular location for a length of time to clean off a particularly stubbornly dirty area of the surface.

An operator may sit in cab 23 of transportation module 30 to operate cleaning vehicle 10. Alternatively, the operator may be located outside of the vehicle's cab 23 when operating cleaning vehicle 10 remotely and may utilize a specially programed computer or hand-held device to control the operation of cleaning vehicle 10, including selectively controlling transportation module 30 or cleaning module 20. In other instances, cleaning vehicle 10 may not require a driver/operator but may instead be operated remotely by a specially designed computer program. For instance, a driverless cleaning vehicle 10 may be specially programmed to perform the required method with little to no human intervention and control.

Cleaning vehicle 10 is used in the following manner. As indicated earlier herein, transportation module 30 of cleaning vehicle 10 includes bed 27 and this bed 27 is used to store brushes 40 when they are not in use for a cleaning operation. The brushes 40 are moved to a storage position when cleaning vehicle 10 is moved from one location to another or when no cleaning operation is currently being undertaken. In order to store brushes 40 upon bed 27, all arms 60, 70, 80 are retracted to their shortest lengths and base 50 is rotated through 180° about axis 3 from the position shown in FIG. 1 to a position where brushes are located directly above bed 27. First arm 60 is then pivoted downwardly toward bed 27 until the bottom end 42 of each brush 40 rests on bed 27. When brushes 40 are to be used for a cleaning operation, these steps are reversed.

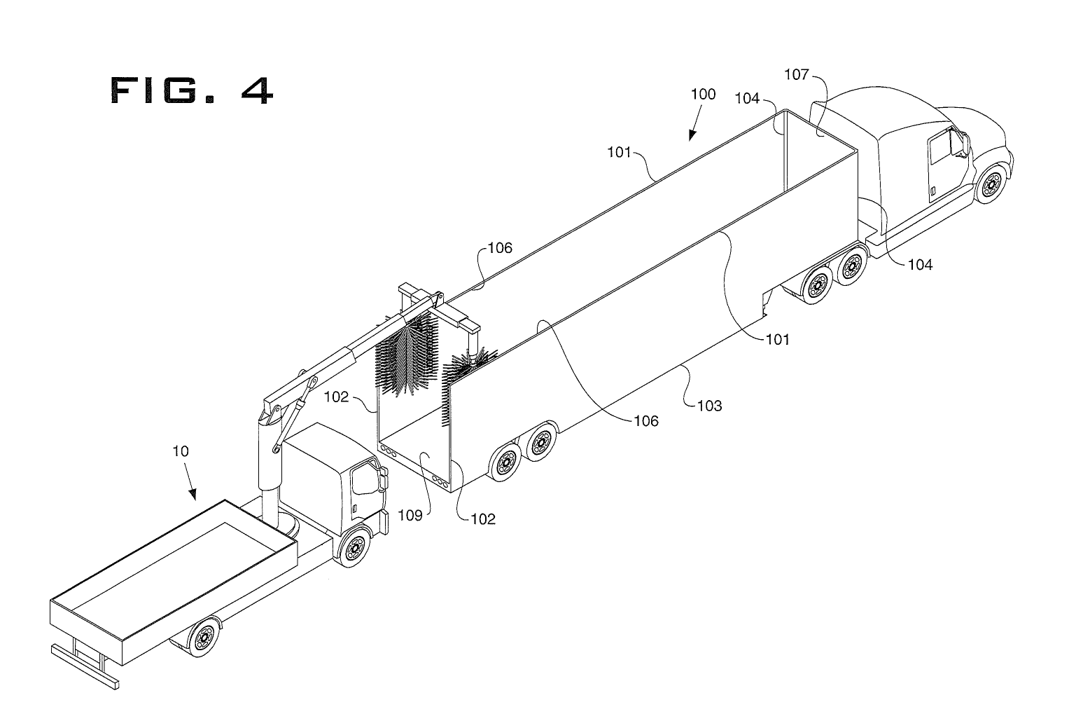

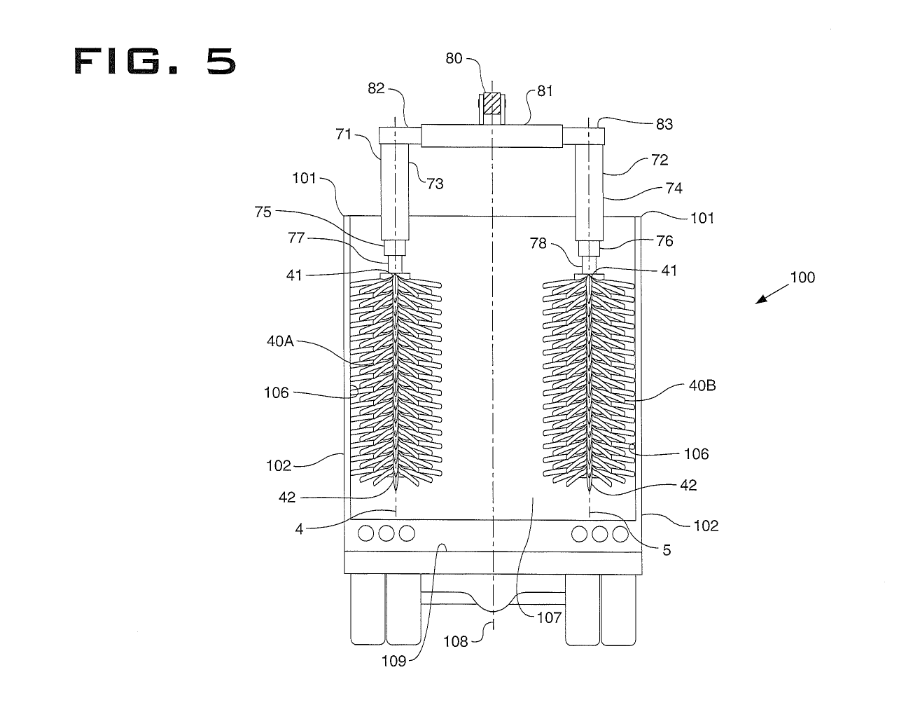

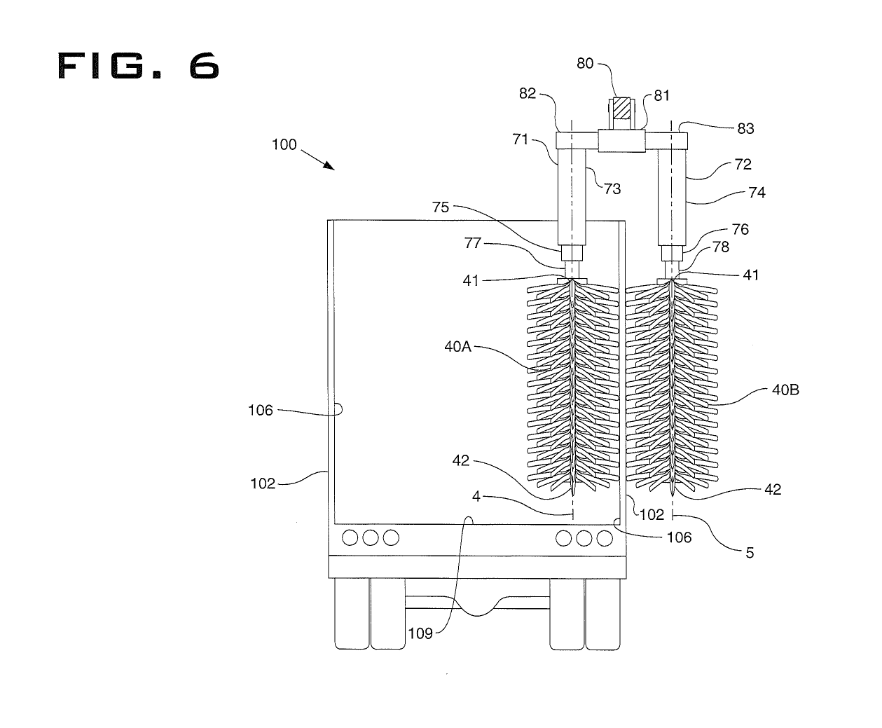

When cleaning vehicle 10 is to be moved to a first location to clean a tractor-trailer 100 for example, cleaning vehicle 10 is driven to the first location and is parked adjacent to tractor-trailer 100. The exact position of cleaning vehicle 10 relative to tractor-trailer 100 is selected based upon which surfaces of tractor-trailer 100 are to be cleaned. Cleaning vehicle 10 may be moved to several different positions around the exterior of tractor-trailer 100, if that is necessary. Cleaning vehicle 10 is, however, designed so that minimal movements may be required to clean both the exterior surfaces of tractor-trailer 100 and the interior surfaces thereof. FIG. 1A and FIG. 2 show cleaning vehicle 10 positioned behind a rear end of tractor-trailer 100 and brushes 40 being used to clean the left and right exterior side surfaces of tractor-trailer 100. FIG. 4 shows cleaning vehicle 10 in the same position behind the rear end of the tractor-trailer 100 and brushes 40 being used to clean the left and right interior surfaces of tractor trailer 100. FIGS. 5 and 6 show brushes 40 being used to clean the exterior rear end of tractor-trailer 100. The position of cleaning vehicle 10 may not need to be changed to perform the cleaning operations shown in FIGS. 1A, 2, 4, 5 and 6.

Referring to FIGS. 1A and 2, tractor-trailer 100 includes a tractor or cab and a trailer that is selectively engaged behind the tractor. The trailer has a front end (proximate the cab), a rear end, a top, and a bottom. The trailer also has two side walls 105, each of which has a top end 101, a bottom end 103, a front end 104, and a rear end 102. Each side wall 105 has an exterior surface and an interior surface. The interior surface is shown in FIGS. 4 and 5 and is identified by the reference number 106.

FIG. 2 shows cleaning vehicle 10 positioned rearwardly of the rear end of the trailer of tractor-trailer 100. As indicated above, when cleaning vehicle 10 is being moved from one location to another, brushes 40 may be stored on bed 27. If this is the case, then when cleaning vehicle 10 stops behind tractor-trailer 100, base 50 may be actuated to increase in length by sliding second portion 52 upwardly relative to first portion 51. This motion lifts bottom ends 42 of brushes 40 off bed 27. Base 50 is then rotated through 180° to move first arm 60 to a position where first arm 60 is generally parallel or aligned with a longitudinal axis of the trailer (where the trailer's longitudinal axis extends between the front and rear ends of the trailer). First arm 60 may be pivoted upwardly slightly about pivot pin 94 so that first arm 60 is located a distance vertically above the top wall of the trailer. First arm 60 may also be actuated to increase in length by telescoping one or more of first, second and third portions, 61, 62, 63 outwardly relative to each other. Simultaneously or prior to the extension of the length of first arm 60, second arm 80 may be actuated and adjusted in length. In particular, one or both of first and second portions 82, 83 may telescoped outwardly from central portion 81 to a degree sufficient to position each one of the brushes 40 adjacent an exterior surface of one of the side walls 105. Third arms 70 may also be actuated and adjusted in length to place brushes 40 in the correct position against each side wall 105. Brushes 40 should be positioned close enough to the exterior surface of the associated side wall 105 so that the bristles thereon will contact the exterior surface but are not so close that the brushes 40 will not freely rotate about their respective axes 4, 5.

When brushes 40 are in position, the operator will actuate the relevant motors to initiate rotation of the brushes 40 to clean the exterior surfaces of side walls 105. As the brushes rotate, the bristles will sweep across walls 105 removing debris therefrom. It will be understood that during the cleaning operation water may be sprayed at the side walls 105 of the trailer and this water may include soap or other cleaning fluids as desired. It will be understood by those of skill in the art that cleaning vehicle may be equipped with a water supply. For instance, a tank may be mounted on bed 27 of cleaning vehicle 10 and water from the tank may be provided to brushes 40 or may be sprayed at the relevant surfaces of trailer 100 to be cleaned. For example, a hose may be connected to the vehicle 10 or to the tank and the other end may be engaged with one or more of arms 60, 70, 80. A nozzle on the hose may be directed to spray water onto side walls 105 or onto brushes 40. In other instances, an operator standing on the ground alongside the tractor-trailer 100 may spray water or a cleaning fluid from a hose attached to a water supply remote from vehicle 10 and onto the surfaces of trailer 100 that are to be cleaned.

During the cleaning operation first arm 60 may be extended in length to cause the rotating brushes 40 to move longitudinally along the side walls 105 from proximate the rear ends 104 of the trailer side walls 105 and towards the front ends 102 thereof. Alternatively, while brushes 40 are rotating, first arm 60 may be retracted so that brushes 40 are moved rearwardly from proximate front ends 102 of side walls 105 to proximate rear ends 104 thereof. The lengths of third arms 70 may also be changed (either extended or retracted as needs be) to sweep the rotating brushes 40 between the top and bottom ends 101, 103 of side walls 105. Additionally, first arm 60 may be pivoted upwardly or downwardly as needed in order to ensure that brushes 40 are moved forwards, backwards, up, and down as many times as is necessary to clean side walls 105. It will be understood that to clean surfaces that are of a greater than typical height, base 50 may also be telescoped outwardly to raise the distance of first arm 60 from a ground surface.

The front and rear ends of trailer 100 may be cleaned in a similar fashion. It may be necessary to move cleaning vehicle to a new position to reach regions of the trailer 100 that are difficult to clean properly from the position shown in FIG. 2. It will be understood that if only one side wall 105 is to be washed, then cleaning vehicle 10 may be positioned rearwardly but off to one side or the other of the trailer 100 so that only one brush 40 will contact the side wall 105 to be cleaned.

FIGS. 4 and 5 show brushes 40 positioned to clean the interior surfaces 106 of both side walls 105 of the trailer. Brushes 40 have to be moved closer to each other to perform this cleaning operation than is the case when the exterior surfaces of the side walls 105 are to be cleaned. Brushes 40 are moved closer together by retracting first and or second portions 82, 83 of second arm 80 into the central portion 81 thereof so that the overall length of second arm 80 is reduced. The cleaning operation is accomplished by actuating first arm 60 to move brushes from proximate rear ends 104 of side walls 105 towards front ends 102 thereof and then back again towards rear ends 104, or vice versa. Additionally, second arms 70 may be adjusted in length to move the brushes up and down the interior surfaces 106 of side walls 105 as needed.

FIG. 6 shows second arm 80 retracted to its shortest length and brushes 40 positioned on either side of one of the side walls 105 of the trailer. Brush 40A is positioned adjacent the interior surface 106 of the side wall 105 and brush 40B is positioned adjacent the exterior surface of the same side wall 105. The cleaning operation is undertaken in the same manner as previously described herein. When one side wall 105 is cleaned, brushes 40A, 40B may be moved and positioned to clean the other side wall 105. In this second instance, brush 40A will clean the exterior surface of that second side wall 105 and brush 40B will clean the interior surface 106 thereof.

When the cleaning operation is completed, arms 60, 70 and 80 are fully retracted to their shortest lengths, base 50 is rotated through 180° to move brushes 40 back over bed 27 of vehicle 10. First arm 60 may be pivoted downwardly and base 50 may be retracted to once again place brushes 40 back in bed 27 of cleaning vehicle 10.

FIG. 1B shows a second embodiment of a transportation module 30 upon which cleaning module 20 may be engaged. In this instance, the cleaning vehicle comprises telescopic handler 200 (also known as a “telehandler”) that includes a cab 202 for an operator, wheels 204, and an extendable base that is mounted to the frame of the telehandler 200. The extendable base may comprises a first portion 206 and a second portion 208 that may be telescoped relative to each other. First portion 206 is mounted via a mounting assembly to a frame of the telehandler 200. The base is able to be angled to a desired angle, such as angle θ, relative to the frame of telehandler 200. The rest of the extendable arm in accordance with the present disclosure, i.e., first arm 60, second arm 80, third arm 70, and brushes 40, is substantially identical in structure and function to the arms 60, 80, 70, and brushes 40 of vehicle 10 shown in FIG. 1A. Second portion 208 on the extendable base of telehandler 200 may be pivotally connected to longitudinally extendable first arm 60 by pivot pin 94 and by hydraulic actuators 90. Telehandler 200 may be operated in substantially the same manner as the way cleaning vehicle 10 operates, i.e., as has been described above. In telehandler 200 the extendable arm that includes first and second portions 206, 208 may be lowered and extended to move the brushes 40 into position for a cleaning operation and may be raised and retracted to move the brushes 40 into a storage position on the back of the vehicle. Cleaning vehicle 10 and telehandler 200 therefore both may operate as mobile cleaning devices that can be moved from location to location to clean a large object such as tractor-trailer 100.

Brushes 40 and/or base 50 (or extendable arm 206, 208), first, second or third arms, 60, 80, 70 may include sensors to aid in determining when the front or rear end 102, 104 or the top or bottom end 101, 103 of a trailer side wall 105 has been reached. When this occurs, motion of the brushes 40 may be halted or the forward/rearward movement or up or down movement of the arms 60, 70 and thereby the brushes 40 may be reversed.

It will be understood that base 50, first arm 60, second arm 80, third arm 70, and extendable arm 206, 208 may comprise the number of portions illustrated and discussed herein or may contain fewer portions or more portions than what is illustrated and described herein.

It will be understood that instead of a simple pivot pin 94, 96 being used as connectors between base 50 and first arm 60; and between first arm 60 and second arm 80, a component that allows for additional degrees of freedom in the pivotal motion of the respective arms may be utilized. Similarly, in telehandler 200, more complex pivotal connectors may be utilized instead of pivot pins 94, 96.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration set out herein are an example and the invention is not limited to the exact details shown or described.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method of cleaning a large object, comprising steps of:
providing a clearing vehicle that is movable from one location to another;
moving the cleaning vehicle alongside a large object to be cleaned;
positioning a brush mounted on the cleaning vehicle proximate a surface to be cleaned on the large object;
contacting the surface with the brush;
actuating the brush; and
cleaning the surface with the actuated brush.

2. The method of claim 1 wherein the cleaning includes moving the brush along the surface.

3. The method of claim 2, further comprising moving the brush laterally or longitudinally or vertically along the surface.

4. The method of claim 1 further comprising rotating the brush.

5. The method of claim 1 further comprising:
mounting an arm on the cleaning vehicle; and
mounting the brush on the arm.

6. The method of claim 5, further comprising selectively extending or retracting the arm to position the brush in contact with the surface or to clean the surface with the brush.

7. The method of claim 6, further comprising extending or retracting the arm longitudinally.

8. The method of claim 6, further comprising extending or retracting the arm transversely.

9. The method of claim 6, further comprising extending or retracting the arm vertically.

10. The method of claim 1, wherein the positioning of the brush includes positioning the brush in contact with an interior surface or an exterior surface of a tractor-trailer′ side wall or rear wall or front wall.

11. An apparatus for cleaning for a large object, comprising:
a frame with a plurality of wheels mounted on the frame, wherein the wheels are adapted to move the frame from one location to another across a ground surface;
an arm mounted to the frame; wherein the arm is selectively adjustable in length;
at least one brush operatively engaged with the arm.

12. The apparatus of claim 11, wherein the arm includes a base that is vertically oriented relative to the frame and is rotatable about a vertical axis.

13. The apparatus of claim 12, wherein the arm includes a first arm that is pivotally engaged with the base; and the first arm is pivotable up or down relative to the frame.

14. The apparatus of claim 13, wherein the first arm is longitudinally adjustable in length.

15. The apparatus of claim 13, wherein the arm further includes a second arm that is engaged with the first arm.

16. The apparatus of claim 15, wherein the second arm is transversely adjustable in length.

17. The apparatus of claim 15, wherein the arm further includes at least one third arm that is engaged with the second arm.

18. The apparatus of claim 17, wherein the at least one third arm is vertically adjustable in length.

19. The apparatus of claim 17, wherein the at least one brush is a single brush that is mounted on each of the at least one third arm and the single brush is mounted for rotation about a vertical axis.

20. The apparatus of claim 19, wherein the at least one third arm comprises two third arms, and a single brush is mounted for rotation on each of the two third arms; and wherein the second arm is adjustable in length to move the two third arms closer to each other or further away from each other.
